(19) United States
(12) Patent Application Publication
(10) Pub. No.: US 2023/0270614 A1
(43) Pub. Date: Aug. 31, 2023

(54) ELECTRIC STRETCHING DEVICE

(71) Applicant: Gil Hyeon PARK, Seoul (KR)

(72) Inventor: Gil Hyeon PARK, Seoul (KR)

(21) Appl. No.: 17/972,543

(22) Filed: Oct. 24, 2022

(30) Foreign Application Priority Data
Feb. 25, 2022 (KR) 10-2022-0024933

(51) Int. Cl. A61H 1/02

(52) U.S. Cl. CPC A61H 1/0266; A61H 1/0262; A61H 2201/1642; A61H 2201/1669; A61H 2201/169; A61H 2201/123; A61H 2201/5035

(57) ABSTRACT

An electric stretching device includes a body part, a mounting part formed on the body part and on which an ankle of a user is configured to be mounted thereon, a driver provided inside the body part and driven so that the mounting part performs a predetermined operation, and a controller configured to control driving of the driver. The mounting part is configured to perform a reciprocating motion repeatedly in an axial direction of the body part within a predetermined range when the driver is driven.

### CROSS-REFERENCE TO RELATED APPLICATION

This application claims priority from and the benefit of Korean Patent Application No. 10-2022-0024933 filed on Feb. 25, 2022, which is hereby incorporated by reference for all purposes as if fully set forth herein.

### BACKGROUND

### Field

Embodiments of the invention relate generally to an electric stretching device, and more particularly, to an apparatus that makes both legs of a user reciprocate in the height direction while the user's ankle, Achilles tendon, or calf region is mounted in a state where the user is lying or seated, or to make both legs of the user alternately reciprocate so that the user's whole body may have an effect similar to a massage, stretching effect, and/or walking exercise.

### DISCUSSION OF THE BACKGROUND

The need for regular exercise for maintaining and/or improving one's physical health is of course desirable to many people, but there are situations in which actual exercise cannot be performed well due to various reasons such as lack of time due to a busy work schedule, decreased motivation due to lack of energy, or cases in which a body is difficult to move due to illness or disability.

Although not necessarily an exercise that accompanies vigorous physical activity, it is widely known that stretching or massage helps to recover from muscle fatigue as well as to regenerate muscles, cells and the like.

In particular, skeletal muscle disease is increasing as the skeletal muscle is narrowed by deformation or stenosis of the skeletal muscle as a person ages. Stretching that pushes and pulls the foot (or leg) may relieve the user's skeletal muscle pain by helping the body's blood circulation without the use of a drug to increase blood circulation. In addition, such stretching may lower the risk of developing skeletal muscle and vascular diseases, so it can be of great help to those who have difficulty in smooth physical activity, such as in-patients or the disabled after surgery.

As such, various devices for stretching or massaging the user are on the market.

However, conventional devices for massage or stretching are not easy to purchase because they are quite expensive, and when the price is low, there are many cases where there is only a massage effect for a certain local area, or the massage is not particularly effective.

In particular, as described above, it may be difficult to use most of the conventional devices for people who lie down for a long time due to chronic diseases, or who do not have the ability to perform any reasonable amount of physical activity, such as in-patients or the disabled after surgery.

Therefore, an apparatus that enables a user to easily manage her/his physical health by providing an effect similar to the effect obtained through an actual walking exercise as well as an excellent stretching effect even when the user is lying down or sitting is required.

The above information disclosed in this Background section is only for understanding of the background of the inventive concepts, and, therefore, it may contain information that does not constitute prior art.

### SUMMARY

An object consistent with one or more embodiments provides the capability of giving a user a whole body stretching effect through a reciprocating motion of both ankles while operating with only the user's ankle part mounted, and giving an effect similar to a walking exercise while making both ankles cross and reciprocate.

According to an aspect to achieve the object, there is provided an electric stretching device including a body part, a mounting part formed on the body part and on which an ankle of a user is configured to be mounted thereon, a driver provided inside the body part and driven so that the mounting part performs a predetermined operation and a controller configured to control driving of the driver, and the mounting part is configured to perform a reciprocating motion repeatedly in an axial direction of the body part within a predetermined range when the driver is driven. By way of example, the predetermined range may be a range of from 6 inches to 18 inches, such that the mounting part moves from a center portion in a direction 6 inches toward the user's torso, and then moves in a direction 12 inches away from the user's torso (passing the center portion along the way), and so on, to create a 6 inches up from a rest position, 6 inches back from the rest position, reciprocating motion of the user's legs.

The mounting part may include a first mounting part on which a left ankle of the user is mounted, and a second mounting part on which a right ankle of the user is mounted, and the driver may include a first driver corresponding to the first mounting part, and a second driver corresponding to the second mounting part.

The controller may selectively control driving of the first driver and the second driver in a stretching mode where the first mounting part and the second mounting part perform reciprocating motions simultaneously in the same direction, respectively, or a walking exercise mode where the first mounting part and the second mounting part cross each other to perform reciprocating motions.

The mounting part may include a support groove formed to accommodate and support the ankle of the user.

The mounting part may further include a cushion material surrounding an inner peripheral surface of the support groove to a predetermined thickness. By way of example, the support cushion material may be some type of soft fabric material made of cotton, Styrofoam, or some other similar type of material, and may be 1 inches to 3 inches in thickness in an unpressed state, and that decreases in thickness when a user's ankle is disposed on the cushion material and thereby presses downwards on the cushion material due to the weight of the ankle.

According to one or more embodiments, it is possible to expect, at least, stretching effects from the legs to the whole body as well as effects similar to walking exercise, so it may be of great help to those who have difficulty in smooth physical activity, such as hospitalized patients or the disabled, after surgery even in a state in which the user is lying down or sitting. Also, ordinary general users may manage their physical health in a more convenient and convenient way, which has the effect of greatly improving user convenience.

Additional features of the inventive concepts will be set forth in the description that follows, and in part will be apparent from the description, or may be learned by practice of the inventive concepts.

### BRIEF DESCRIPTION OF THE DRAWINGS

The accompanying drawings, which are included to provide a further understanding of the invention and are incorporated in and constitute a part of this specification, illustrate illustrative embodiments of the invention, and together with the description serve to explain the inventive concepts.

FIG. 1 illustrates a schematic configuration of an electric stretching device according to an embodiment.

FIG. 2 is a diagram for illustrating an example of use of an electric stretching device according to an embodiment.

FIG. 3 and FIG. 4 are diagrams for illustrating a crossing operation of an electric stretching device according to an embodiment.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing illustrative features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the x-axis, the y-axis, and the z-axis are not limited to three axes of a rectangular coordinate system, and may be interpreted in a broader sense. For example, the x-axis, the y-axis, and the z-axis may be perpendicular to one another, or may represent different directions that are not perpendicular to one another. For the purposes of the embodiments described herein, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the embodiments described herein.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

In embodiments, the controller, and/or one or more components thereof, may be implemented via one or more general purpose and/or special purpose components, such as one or more discrete circuits, digital signal processing chips, integrated circuits, application specific integrated circuits, microprocessors, processors, programmable arrays, field programmable arrays, instruction set processors, and/or the like.

According to one or more embodiments, the features, functions, processes, etc., described herein may be implemented via software, hardware (e.g., general processor, digital signal processing (DSP) chip, an application specific integrated circuit (ASIC), field programmable gate arrays (FPGAs), etc.), firmware, or a combination thereof. In this manner, the controller, and/or one or more components thereof may include or otherwise be associated with one or more memories (not shown) including code (e.g., instructions) configured to cause the controller, and/or one or more components thereof to perform one or more of the features, functions, processes, etc., described herein.

The memories may be any medium that participates in providing code to the one or more software, hardware, and/or firmware components for execution. Such memories may be implemented in any suitable form, including, but not limited to, non-volatile media, volatile media, and transmission media. Non-volatile media include, for example, optical or magnetic disks. Volatile media include dynamic memory. Transmission media include coaxial cables, copper wire and fiber optics. Transmission media can also take the form of acoustic, optical, or electromagnetic waves. Common forms of computer-readable media include, for example, a floppy disk, a flexible disk, hard disk, magnetic tape, any other magnetic medium, a compact disk-read only memory (CD-ROM), a rewriteable compact disk (CD-RW), a digital video disk (DVD), a rewriteable DVD (DVD-RW), any other optical medium, punch cards, paper tape, optical mark sheets, any other physical medium with patterns of holes or other optically recognizable indicia, a random-access memory (RAM), a programmable read only memory (PROM), and erasable programmable read only memory (EPROM), a FLASH-EPROM, any other memory chip or cartridge, a carrier wave, or any other medium from which information may be read by, for example, a controller/processor.

Unless otherwise defined, all terms (including technical and scientific terms) used herein have the same connotation as commonly understood by one of ordinary skill in the art to which the embodiments described herein are directed to. Terms, such as those defined in commonly used dictionaries, should be interpreted as having a connotation that is consistent with their connotation in the context of the relevant art and should not be interpreted in an idealized or overly formal sense, unless expressly so defined herein.

Hereinafter, embodiments will be described in detail with reference to the accompanying drawings. Like reference numerals in each figure refer to like components.

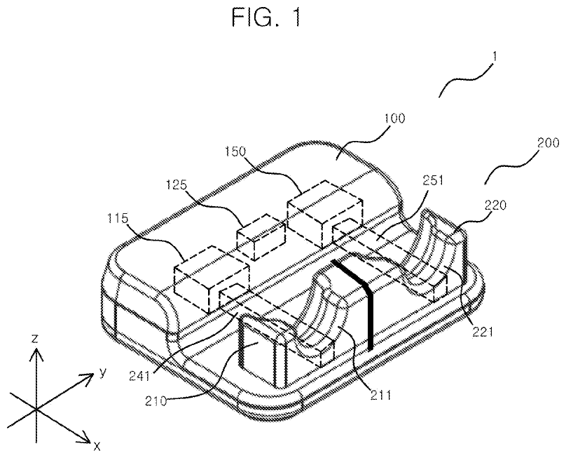

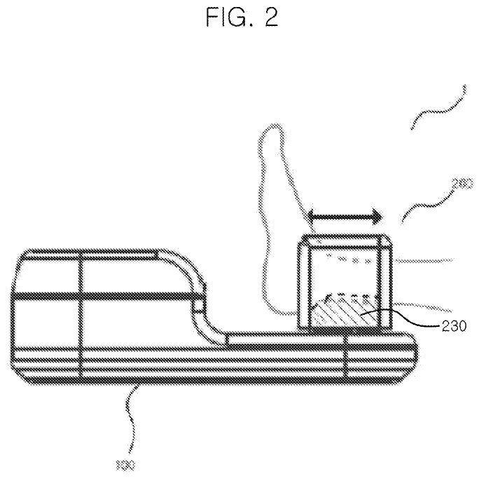

FIG. 1 illustrates a schematic configuration of an electric stretching device that is constructed consistent with an embodiment, and FIG. 2 is a diagram for illustrating an example of use of an electric stretching device according to an embodiment.

First, referring to FIG. 1, an electric stretching device 1 according to an embodiment may include a body part 100, a mounting part 200 formed on the body part 100 and on which a user's ankle is mounted, first and second drivers 115, 150 provided inside the body part 100 to reciprocate the mounting part 200, and a controller 125 for controlling the driving of the first and second drivers 115, 150.

For convenience of description, an x-axis direction illustrated in the drawings is referred to as an axial direction, a y-axis direction is referred to as a width direction, and a z-axis is referred to as a height direction.

According to an embodiment, each of the first and second drivers 115, 150 may include a motor driven through power supplied from an external or internal battery, (not shown) and a connection part 241, 251 for respectively connecting the motors of the first and second drivers 115, 150 to the mounting part 200, and be implemented so that the mounting part 200 may perform a predetermined operation, for example, a reciprocating motion in the axial direction by rotation of the motors.

For example, in one embodiment each connection part 241, 251 may include a crank structure, and may be implemented to transform the rotational motion of the motors into a reciprocating motion of the mounting part 200. As such, a structure for transforming the rotational motion into the reciprocating motion by using a crank or a crankshaft is widely known, and thus, further detailed description thereof will be omitted herein for sake of brevity.

Alternatively, in another embodiment, the motors and/or the mounting part 200 is provided with a gear wheel, respectively, and each connection part 241, 251 may be formed in a bar shape or a chain shape having a concave-convex shape that may be engaged with each gear wheel, so that the mounting part 200 may move in a predetermined direction while the connection part moves or rotates according to the rotation of the motors.

In any case, the embodiments described herein may be implemented such that the mounting part 200 is moved in the axial direction by the driving of the first and second drivers 115, 150, and in particular the mounting part 200 may reciprocate within a predetermined range in the axial direction.

As illustrated in FIG. 2, the movement of the mounting part 200 shakes ankles of the lying user in the direction of the user's height (horizontally in the view as shown in FIG. 2) when the user's ankles are mounted on the mounting part 200. This may have the effect that the user's whole body skeletal muscle shakes in a certain direction and repeats contraction and relaxation, thereby bringing about a stretching effect of the user's legs as well as the whole body.

To this end, the mounting part 200 may include support grooves 211 and 221 for supporting the mounted user's ankles.

Each of the support grooves 211 and 221 may be formed to have a U-shaped cross-section with an open upper part and a streamlined lower part as illustrated in the drawings, but is not necessarily limited thereto, and the support grooves may be formed in various shapes if the user does not feel discomfort or pain while the user's ankles are being supported by the support grooves.

According to an embodiment, the inner peripheral surfaces of the support grooves 211 and 221, in other words, the parts in which the user's ankles are mounted and with which the ankles are in direct contact, may be provided with a predetermined cushion material 230 so as to feel a cushioning feeling, as shown in FIG. 2.

When the user mounts the ankles in the support grooves 211 and 221, the rear parts of the user's ankles, for example, the user's Achilles tendons, may be accommodated in the support grooves 211 and 221 and supported by the support grooves 211 and 221, and the user's heels may be located outside the mounting part 200, as shown in FIG. 2.

With the support grooves 211 and 221 formed in the mounting part 200, the lower ends of the support grooves 211 and 221 have a predetermined height from the upper surface of the body part 100. Therefore, the user's heel may be slightly floating in the air, as shown in FIG. 2.

Therefore, even if the mounting part 200 reciprocates in the axial direction of the body part 100, the user's heels do not touch the floor, that is, the upper surface of the body part 100 such that the user's heels do not move and rub against the upper surface of the body part 100.

According to an embodiment, the mounting part 200 may be configured to include a first mounting part 210 and a second mounting part 220 on which the user's left and right ankles are respectively mounted.

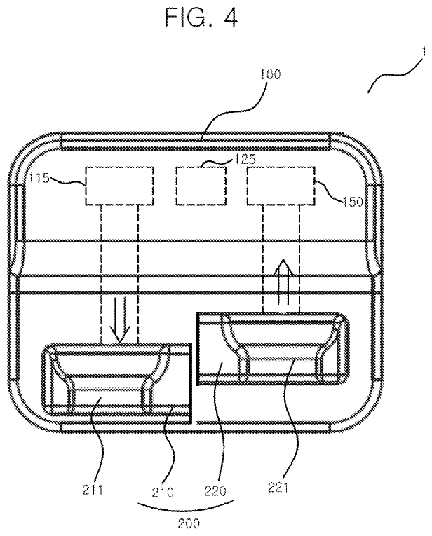

In this case, the first and second drivers 115, 150 that respectively drive the first and second mounting parts 210, 220 by way of the first and second connection parts 241, 251, may be separately provided, as shown in FIG. 1 and FIG. 4. That is, the first driver 115 may be implemented to drive the first mounting part 210, and the second driver 150 may be implemented to drive the second mounting part 220, under control of the controller 125. In this case, a connection structure 241 between the first driver 115 and the first mounting part 210 and a connection structure 251 between the second driver 150 and the second mounting part 220 may be the same as the structure between a single driver, which performs the functions of the first and second drivers 115 and 150, and the mounting part 200.

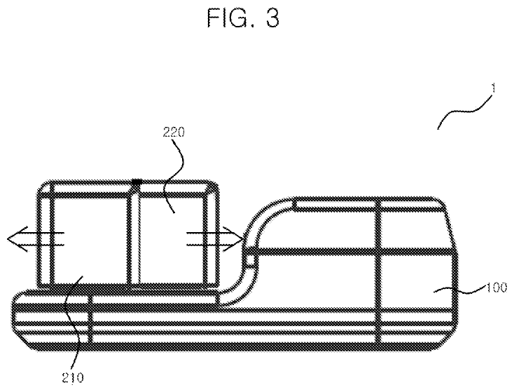

According to an embodiment, when the connection parts 241, 251 include the above-described crank structure, the first mounting part 210 and the second mounting part 220 cross each other through a single driver that performs the functions of the first and second drivers 115, 150, and that performs the reciprocating motion. Examples of this are illustrated in FIGS. 3 to 4.

FIG. 3 and FIG. 4 are diagrams for illustrating a crossing operation of the electric stretching device according to an embodiment, in which FIG. 3 is a side view of the apparatus 1 and FIG. 4 is a plan view of the apparatus 1.

Referring to the drawings, the mounting part 200 may be divided into the first mounting part 210 and the second mounting part 220 as described above. In addition, the support grooves 211 and 221 may be formed in the first mounting part 210 and the second mounting part 220, respectively, so that the user may mount one ankle on the first mounting part 210 and mount the other ankle on the second mounting part 221, and thus mount both ankles onto the apparatus 1 at the same time.

The controller 125 may control the driver, that is, the first driver 115 and the second driver 150, so that the first mounting part 210 and the second mounting part 220 cross each other and perform the reciprocating motion.

For example, when the first mounting part 210 moves toward the user's head in the axial direction, the second mounting part 220 may move toward the user's feet in the axial direction.

As such, when the first mounting part 210 and the second mounting part 220 cross and perform the reciprocating motion, the user may alternately stretch the skeletal muscles from both ankles, and the whole body may shake, twist, or otherwise move due to the movement of the ankles so that an effect similar to a walking exercise is obtained.

The controller 125 may selectively control the operations of the first mounting part 210 and the second mounting part 220, that is, the mounting part 200 as described above. The operations may be determined by the user's input.

For example, the controller 125 may determine the operation of the mounting part 200 according to the user's mode input. In this case, the electric stretching device 1 may be provided with a predetermined input device (e.g., a button, a switch, a touch pad, etc.) that may receive or select a desired mode from the user. By way of example, a handheld remote control device may be provided to receive the user's mode input, whereby the user presses a button or buttons to cause the controller 125 to receive a first signal to cause the first driver 115 and the second driver 150 to enter the stretching mode, or to cause the controller 125 to receive a second signal to cause the first driver 115 and the second driver 150 to enter the walking exercise mode.

In an example, when the user selects a stretching mode, the controller 125 may control the first driver 115 and the second driver 150 so that the first mounting part 210 and the second mounting part 220 reciprocate in the same direction at the same time. In other words, in the stretching mode, both legs of the user may simultaneously reciprocate in the same direction, and the stretching effect may be maximized while contracting/relaxing the user's whole body skeletal muscles.

Alternatively, when the user selects a walking exercise mode, the controller 125 may control the driving of the first driver 115 and the second driver 150 so that the first mounting part 210 and the second mounting part 220 cross each other (e.g., the first mounting part 210 moves inwards while the second mounting part 220 moves outwards at the same time) and reciprocate.

The controller 125 may perform a function of controlling algorithms and operations of other components for implementing the embodiments as described above. To this end, the controller 125 may include a processor, a storage device, and a predetermined program stored in the storage device and executed by the processor. In the embodiments described herein, when the controller 125 performs a predetermined operation (e.g., driving control of the driver, mode input, etc.), an average expert in the technical field of the embodiments described herein may easily infer that a series of data processing and/or control by the processor executing the program may be performed by the controller 125.

According to the embodiments as described above, stretching effects from the legs to the whole body as well as effects similar to walking exercise may be expected, so it may be of great help to those who have difficulty in smooth physical activity, such as hospitalized patients or the disabled, after surgery even in a state in which the user is lying down or sitting. Also, ordinary general users may manage their physical health in a more convenient and convenient way, which has the effect of greatly improving user convenience in obtaining a useful exercise.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. An electric stretching device comprising:
a body part;
a mounting part formed on the body part and on which an ankle of a user is to configured to be mounted thereon;
a driver provided inside the body part and driven so that the mounting part performs a predetermined operation; and
a controller configured to control driving of the driver,
wherein the mounting part is configured to perform a reciprocating motion repeatedly in an axial direction of the body part within a predetermined range when the driver is driven.

2. The electric stretching device of claim 1, wherein the mounting part comprises:
a first mounting part on which a left ankle of the user is mounted; and
a second mounting part on which a right ankle of the user is mounted, and
wherein the driver comprises:
a first driver configured to drive the first mounting part, and
a second driver configured to drive the second mounting part.

3. The electric stretching device of claim 2, wherein the controller selectively controls the first driver and the second driver in either: i) a stretching mode where the first mounting part and the second mounting part perform reciprocating motions simultaneously in the same direction, respectively, or
ii) a walking exercise mode where the first mounting part and the second mounting part cross each other to perform reciprocating motions.

4. The electric stretching device of claim 1, wherein the mounting part comprises a support groove formed to accommodate and support the ankle of the user.

5. The electric stretching device of claim 4, wherein the mounting part further comprises a cushion material surrounding an inner peripheral surface of the support groove to a predetermined thickness.

6. The electric stretching device of claim 1, wherein the body part has an interior region encased by an outer shell, and
wherein the driver is positioned within the interior region.

7. The electric stretching device of claim 3, further comprising:
a handheld remote control device that is configured to receive a user input to cause the first driver and the second driver to operate in either the stretching mode or in the walking exercise mode,
wherein, based on an input by the user on the handheld remote control device, the controller receives either a first signal to cause the first driver and the second driver to operate in the stretching mode, or a second signal to cause the first driver and the second driver to operate in the walking exercise mode.

8. The electric stretching device of claim 4, wherein the support groove has a U-shaped structure.

9. The electric stretching device of claim 2, further comprising:
a first connection part configured to connect the first driver with the first mounting part and to cause the first mounting part to move based on a direction and an amount of drive force provided by the first driver; and
a second connection part configured to connect the second driver with the second mounting part and to cause the second mounting part to move based on a direction and an amount of drive force provided by the second driver.

10. The electric stretching device of claim 9, wherein each of the first and second connection parts comprises a bar or a chain and that has a concave-convex shape, for causing the first and second mounting parts to move in a particular manner.

11. The electric stretching device of claim 9, wherein each of the first and second connection parts comprises a crank or a crankshaft, for causing the first and second mounting parts to move in a particular manner.
